(19) United States
(12) Patent Application Publication
(10) Pub. No.: US 2026/0048598 A1
(43) Pub. Date: Feb. 19, 2026

(54) Platen Belt Drive Assembly

(71) Applicant: ZEBRA TECHNOLOGIES CORPORATION, Lincolnshire, IL (US)

(72) Inventors: Mark B. Urban, Mundelein, IL (US); Richard J. Preliasco, North Kingstown, RI (US); Daniel P. Lanigan, Elgin, IL (US)

(21) Appl. No.: 18/807,540

(22) Filed: Aug. 16, 2024

(51) Int. Cl. B41J 11/14; B41J 3/407; B41J 11/057; B65G 23/44

(52) U.S. Cl. CPC B41J 11/14; B41J 3/4075; B41J 11/057; B65G 23/44

(57) ABSTRACT

A printer is disclosed that includes a platen assembly, a printer outlet, and a media feed path. The platen assembly includes a belt, a platen roller and guide roller, and a tensioning roller. The belt is driven along a belt path by any one of the platen roller, the guide roller, or the tensioning roller. The printer outlet is positioned adjacent to the platen assembly. The media feed path extends from a media supply to the printer outlet. The media feed path passes adjacent to the platen roller. The belt path intersects the media feed path in proximity to the platen roller at an angle of 30-90 degrees.

### BACKGROUND

Media processing devices, or printers, were developed to allow a user to process media on-demand. Linerless type media is preferred in some instances by users as the media does not have a backing web applied and therefore results in less waste. However, issues arise in using linerless type media which includes, for example, the build-up of adhesive on internal components of the printer and the media sticking to components.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example media processing device in accordance with embodiments of the present disclosure.

FIG. 2 illustrates the example media processing device of FIG. 1 with an access door assembly in an open position in accordance with embodiments of the present disclosure.

FIG. 3 illustrates a side profile of an internal cavity of the example media processing device of FIG. 1 in accordance with embodiments of the present disclosure.

FIG. 4 illustrates an enhanced view from a section noted in FIG. 3 in accordance with embodiments of the present disclosure.

FIG. 5 illustrates a belt assembly of the media processing device of FIG. 1 in accordance with embodiments of the present disclosure.

FIG. 6A illustrates an example roller of an embodiment of the belt assembly in accordance with embodiments of the present disclosure.

FIG. 6B illustrates another example roller of an embodiment of the belt assembly in accordance with embodiments of the present disclosure.

FIG. 7 illustrates another example media processing in accordance with embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Embodiments of media processing devices of the present disclosure, such as printers, can process (e.g., print, encode, etc.) media by drawing the media from the media source and routing the media proximate various processing components (e.g., printhead, RFID reader/encoder, magnetic stripe reader/encoder etc.). Processing the media from the media source may facilitate a continuous or batch printing process.

Such media may include a continuous web such as a spool of linerless media. The continuous web of linerless media is coated on one surface with a pressure sensitive adhesive and includes a printable surface on the opposite surface. For thermal transfer printing, the printable surface of the linerless media is configured to receive a pigment (e.g., ink, resin, wax-resin, etc.) that is transferred from a ribbon supply. For direct thermal printing, a thermal printhead of the printer directly contacts the printable surface triggering a chemical and/or physical change in a thermally sensitive dye covering and/or embedded in at least a portion of the printable surface of the media.

When the media is a linerless-type media, the side of the media including the adhesive is in contact with the components of the media processing devices, which may cause the adhesive to transfer to the components, causing the surface of the components to become sticky and adhere to media unintendedly. For conventional media processing device that utilize a platen roller that comes in direct contact with the adhesive of the media, the adhesive can build up on the platen roller causing degrading performance of the platen roller over time and/or the adhesive can cause the media to stick to the platen roller such that the media wraps around the platen roller as the platen roller rotates. Further wear may be caused by the adhesive contacting the platen roller surface and forming mars in the surface. Rather than utilizing a platen roller in direct contact with the media, embodiments of the present disclosure advantageously provide for a media processing device with a belt assembly that includes a belt, a portion of which comes into contact with the adhesive side of the media at any given time. As the belt can have a greater surface area than the platen roller, embodiments of the media processing device of the present disclosure can advantageously process more linerless-type media before the buildup of adhesive on the belt begins to cause issues.

In accordance with embodiments of the present disclosure, a printer and/or media processing device is disclosed. A printer is disclosed that includes a platen assembly, a printer outlet, and a media feed path. The platen assembly includes a belt, a platen roller and guide roller, and a tensioning roller. The belt is driven by along a belt path by any one of the platen roller, the guide roller, or the tensioning roller. The printer outlet is positioned adjacent to the platen assembly. The media feed path extends from a media supply to the printer outlet. The media feed path passes adjacent to the platen roller. The belt path intersects the media feed path in proximity to the platen roller at an oblique angle.

A further embodiment includes wherein the platen assembly further includes a tensioner configured to adjust the tensioning roller to modify tension in the belt.

Another embodiment includes wherein the media supply is linerless media.

A further embodiment includes wherein the platen roller includes a plurality of pins configured to interact with the belt. Alternatively, or additionally, the belt includes a plurality of pin holes configured to receive the plurality of pins.

Another embodiment includes wherein the platen roller is positioned adjacent to a printhead assembly within the printer.

A further embodiment includes wherein the belt path intersects the media feed path at an angle of 30-45 degrees.

Another embodiment includes wherein the belt is replaceable.

Further embodiments include wherein the guide roller includes alignment features configured to maintain alignment of the belt. Additionally, or alternatively, the alignment features include tapered ends of the guide roller.

Another embodiment includes wherein the belt is in contact with media over less than 10% of the belt at any time during operation.

An embodiment supported by the disclosure below includes a belt assembly including a belt, a platen roller, a guide roller, and a tensioning roller. The belt is configured to drive the media past a printhead assembly, the belt including a plurality of pin holes. Any one of the platen roller, guide roller, or tensioning roller can be configured to drive the belt around the platen assembly, the platen roller includes a plurality of pins concentrically arranged around the platen roller, the plurality of pins configured to align with the plurality of pin holes. The guide roller configured to maintain alignment of the belt as it passes around the platen assembly. The tensioning roller is configured to control the tension on the belt.

Further embodiments include a tensioner is configured to adjust a position of the tensioning roller. Additionally, or alternatively, the tensioner includes a rack and pinion system and tensioning structure includes a tensioning wheel configured to drive the rack and pinion system which adjusts the position of the tensioning roller.

Additional embodiments include wherein the tensioning roller can be adjusted for removal of the belt.

An embodiment supported by the disclosure below includes a printer including a printhead; a platen assembly, and a media feed path. The platen assembly includes a belt, a platen roller, a guide roller, and a tensioning roller, wherein the belt is driven along a belt path by any one of the platen roller, the guide roller, or the tensioning roller. The media feed path extends from a media supply to a printer outlet, wherein the media feed path passes adjacent to the platen roller. The belt path intersects the media feed path in proximity to the drive roller at an angle of 1-20 degrees.

Further embodiments include wherein the platen assembly is positioned on the underside of the printer.

Additional embodiments include wherein the media supply is linerless media.

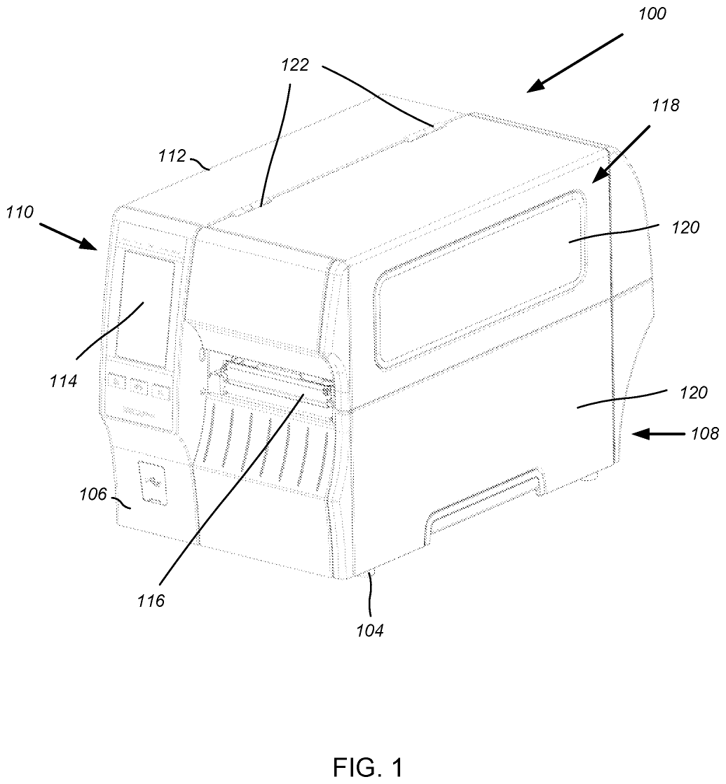

FIGS. 1-3 illustrate an example of a media processing device 100 in accordance with embodiments of the present disclosure. In the present example, the media processing device 100 can be a printer. The media processing device 100 includes a housing 102 and a base 104. The housing 102 may include one or more front panels 106, a rear panel 108, a side panel 110, a support surface 112, and an access door or cover assembly 118. The housing 102 may include a user interface 114 and a media outlet or exit 116. The media exit 116 may be arranged in one of the one or more the front panels 106 of the media processing device 100 and may be configured to expel media through a slot after it has been processed. The access door assembly 118 includes one or more doors or covers 120 and can be hingedly attached to the support surface 112 with hinges 122. The access door assembly 118 is illustrated in the closed or operational position in FIG. 1, in which access to the internal components of the media processing device 100 is precluded. In addition to keeping dirt, dust, and foreign objects from entering an internal cavity of the media processing device 100 and potentially contaminating the consumables or the electronics of the media processing device 100, the closed position of the access door assembly 118 may also reduce noise and prevent users from inadvertently touching sensitive components.

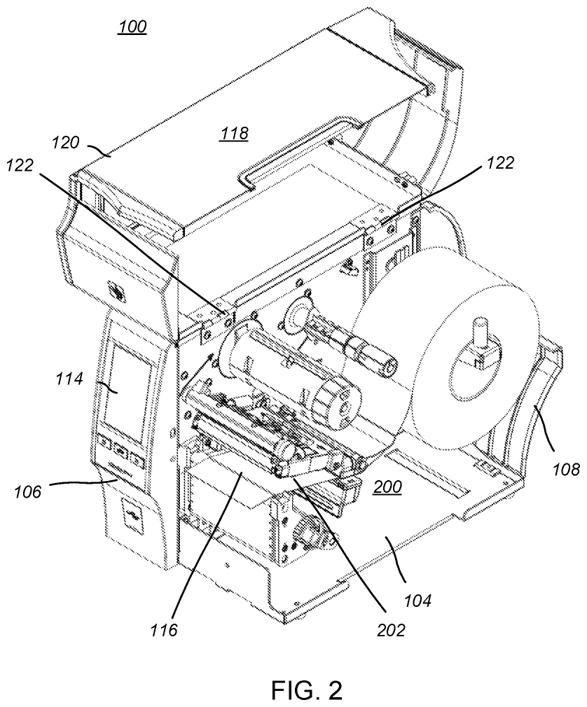

The access door assembly 118 may pivot about hinges 122 through a range of approximately 180 degrees to a major support position to provide access to an interior cavity 200 of the media processing device 100 in an open or non-operational position as illustrated in FIG. 2. The hinges 122 may be located proximate a centerline of the housing 102 defined between the support surface 112 and the access door assembly 118. Positioning the hinges 122 proximate a centerline of the housing 102 allows the access door assembly 118 to pivot about hinges 122 and achieve the support position when the access door assembly 118 comes to rest on the support surface 112. In some embodiments, the access door assembly 118 may include at least a portion of the one or more front panels 106 and/or a portion of the rear panel 108 to provide greater access to the interior cavity 200 when the access door assembly 118 is positioned in the open position. Operation of the media processing device 100 may be precluded when the access door assembly 118 is in the open position.

As shown in FIGS. 2-4, when the access door assembly 118 is in the open position, components for loading and unloading consumables (e.g., print media and printer ribbon) within internal cavity 200 can be accessible and components associated with processing media along a media feed path 202 (or feed path 202) can be viewed. Access to the internal cavity 200 can be provided, for example, at least partially, through at least three sides (e.g., the front side via a portion of the one or more front panels 106, the access door side and top side through the access door assembly 118, and/or the rear side 108) which permit easier access and view of the components within the cavity 200.

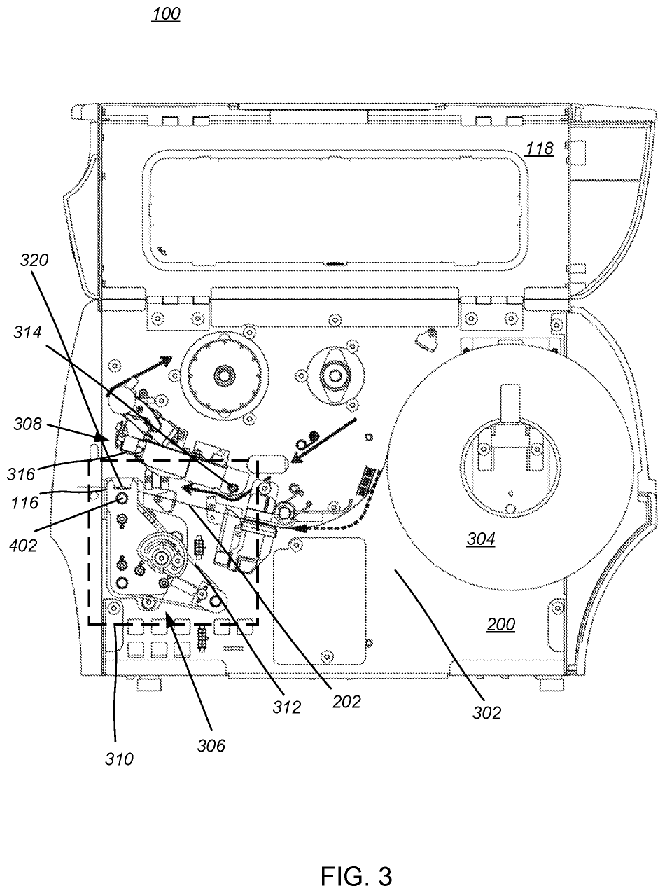

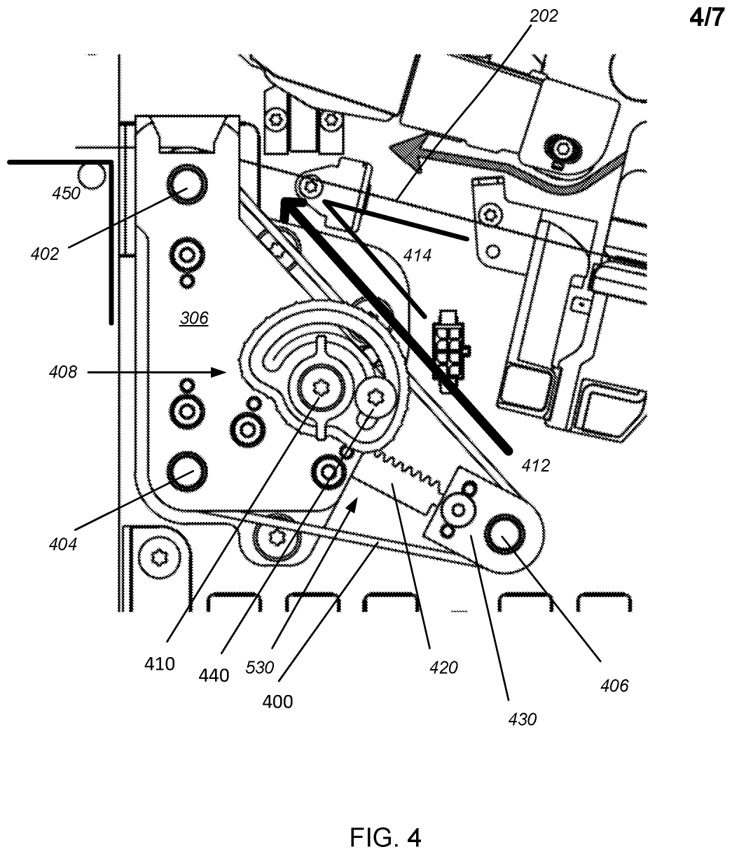

FIG. 3 illustrates a side view of the media processing device 100 with the access door assembly 118 in the open position and showing the internal cavity 200 and a chassis 302 that supports at least some of the components for processing a media supply 304 along the feed path 202. The media processing device 100 further includes a platen assembly 306 and a printhead assembly 308. Box 310 in FIG. 3 highlights an area including the platen assembly 306, the feed path 202, and a platen length 312 and FIG. 4 illustrates an enhanced view of box 310 of FIG. 3. As illustrated in FIG. 4, the platen assembly 306 includes a platen belt 400 which passes over three separate rollers. The rollers (e.g., shown in FIG. 4) include a platen roller 402, a guide roller 404, and a tensioning roller 406. Any one of the rollers 402, 404, and 406 can be driven (e.g., by a motor) to drive the belt along a belt path 412. The belt path 412 is linear and substantially parallel to the belt 400 as it passes between the rollers 402, 404, and 406 (e.g., from the tensioning roller 406 and the platen roller 402) and general follows a curvature of the rollers 402, 404, and 406 at points of contact with the rollers 402, 404, and 406.

The printhead assembly 308 is pivotable about a pivot 314. The printhead assembly 308 is configured to support a thermal printhead 316 (printhead 316). The printhead assembly 308 is pivotable between an engaged position and a disengaged position (disengaged position shown in FIG. 3) wherein when the printhead assembly 308 is in the engaged position, the printhead 316 is adjacent to the platen assembly 306 and defines a print line 320 at which the printhead 316 is configured to print on media.

The feed path 202 depicts the flow of media from the media supply 304 to the outlet 116, between which, the media passes the printhead 116 and through the print line 320 for processing. In order for the printhead 116 to properly process the media, it is required that adequate pressure be applied by the printhead 116 against the media at the print line 320. To reach the desired pressure, the platen roller 402 of the platen assembly 306 is positioned adjacent and opposite to the printhead 316 with the belt 400 positioned between the platen roller 402 and the printhead 316, where the platen roller 402 supports the media on the belt 400 from a side opposite from which the printhead 316 applies its force. The platen roller 402 with the belt 400 and the printhead 316 form a “nip” at the point in which they meet, where the nip is a slight deformation of the platen roller 402 (and the belt 400) due to the pressure applied by the printhead 316. The pressure from the printhead 316 further allows the platen roller 402 to drive the media on the belt 400 forward by rotating the platen roller 402, where the belt 400 grips the media (e.g., via friction) and slides the media against the printhead 316 at the print line 320 for processing. After processing via the printhead 316, the processed media is ejected from the media processing device 100 via the outlet 116. As described herein, for linerless type media, the side of the media against the blet 400 includes adhesive, which is sticky and prone to leave residue on the belt 400 during processing. By minimizing how much of the linerless type media is in contact with the belt at any given time (e.g., no more media contacts the belt 400 than is necessary), the amount of residue build up and/or the rate at which residue builds up can be minimized and the rate at which the belt wears can be reduced. The amount of the linerless media that is in contact with the belt 400 at given time is a product of a relationship between the feed path 202 and the belt path 412 such that if the feed path 202 introduces the media to the belt 400 at the last opportunity to do so (e.g., as proximate to the platen roller and/or the print line 320 at which the printhead renders an image on the media), the media contacts a small portion of the belt 400 for a minimum amount of time, resulting in less contact and less time for the adhesive to transfer from the media to the belt 400. The relationship between the feed path 202 and the belt path can be determined by a where the media on the feed path 202 is introduced to the belt 400 on the belt path 412 as well as an angle at which the media on the feed path 202 converges with the belt 400 on the belt path.

The belt configuration described below aids in reducing build up of adhesive on the surface of the platen by increasing the surface area of the platen in which the adhesive is collected which acts to increase the overall life span of the belt before it needs replacing or maintenance (e.g. cleaning.)

The tensioning roller 406 is moveable via interaction with the tensioner 408 which includes a tensioning wheel 410.

FIG. 4 further illustrates angle 414, which is the angle between the feed path 202 and the belt path 412. The angle 414 ensures that the belt 400 and the feed path 202 remain separated until feed path intersects the belt path 412 proximate to the platen roller 402 and/or the print line 320. In maximizing the efficiency of the platen assembly 306, keeping the media feed path 202 at an angle and/or positioning the feed path 202 such that it intersects the belt path 412 proximate to the platen roller and/or the print line 320 and only contacts the platen belt 400 just before printing and then separates again right after allows the platen belt 400 to accumulate adhesive from the labels at a slower rate. The angle 414 can be an oblique angle. In one example, the angle 414 can be between 1 degree and 179 degrees, or between 1 degree and 20 degrees, or between 30 degrees and 35 degrees. An exit angle 450 is representative of the feed path 202 in relation to the platen belt 400 after the feed path 202 passes the platen roller 402. The exit angle 450 can be an oblique angle. In one example, the exit angle 450 can be between 179 degrees and 1 degree, or between 80 degrees and 100 degrees. In one example, the media can contact less than twenty-five percent (25%) of the belt as it is advanced along the feed path by the belt. As another example, the media can contact less than ten percent (10%) of the belt as it is advanced along the feed path by the belt. As another example, the media can contact less than ten percent (5%) of the belt as it is advanced along the feed path by the belt. As another example, the media can contact between one percent (1%) and twenty-five percent (25%) of the belt 400

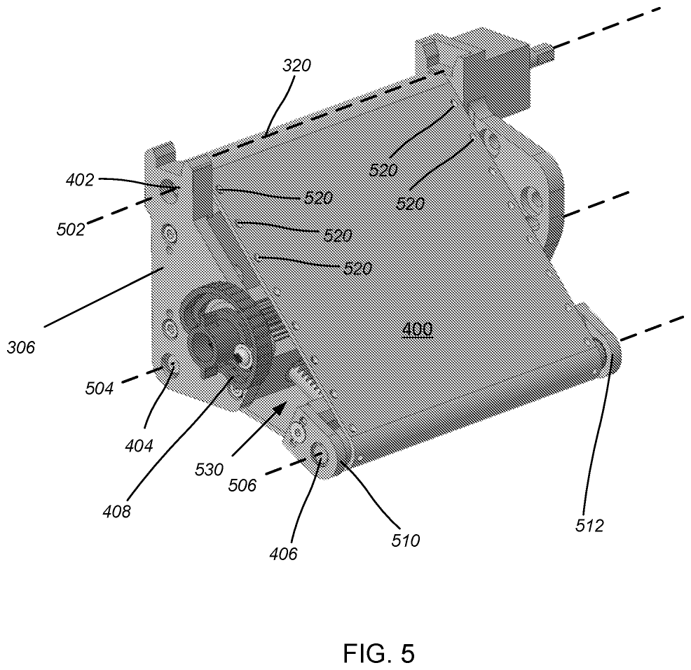

FIG. 5 illustrates another perspective of the platen assembly 306 of FIG. 4. In the illustrated embodiment, a width of the platen belt 400 extends from a first side 510 of the platen assembly 306 to the second side 512. The platen belt 400 is driven due to the rotation of anyone of the platen roller 402, the guide roller 404, or the tensioning roller 406. As an example, the platen roller 402 can rotate about axis 502, which is concentric to the platen roller 402.

In one example, the platen roller 402 is configured to be driven to rotate by a motor of the media processing device 100. The platen roller 402 is configured to engage with the belt 400 such that when the platen roller 402 rotates, the platen belt 400 is pulled around the platen roller 402. As depicted in FIG. 5, the belt 400 features a plurality of pin holes 520 (or singular pin hole 520). The pin holes 520, as depicted, are arranged in two linear sets, evenly spaced, on each edge of the belt 400 along a length of the belt 400. In other embodiments, the pin holes 520 may only be along one side of the belt 400 or positioned elsewhere along the platen belt 400.

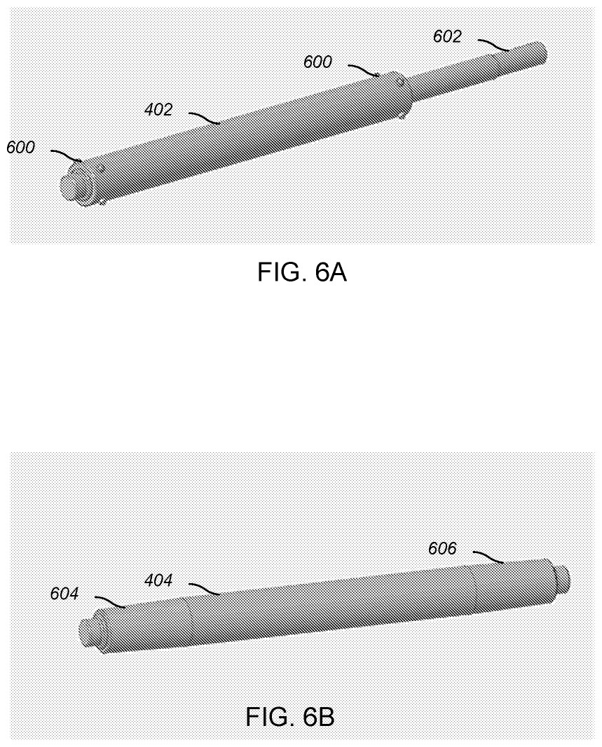

Referring to FIG. 6A, depictions of the platen roller 402 is shown. In the depicted embodiment, the platen roller 402 includes a plurality of pins 600. The pins 600 (or pin 600) are spaced radially around the platen roller 402 and are configured to interact with the pin holes 520 of the platen belt 400. The pins 600 are equally spaced around the platen roller 402 which allows for continuous rotation of the platen roller 402 to pull the belt 400. The platen roller 402 further includes a drive axle 602 configured to mate with a motor (unseen). The motor operably controls the platen roller 402 and controls the amount of rotation of the platen roller 402 which in turn controls the distance the drive belt 400 is driven.

FIG. 6B depicts an example guide roller 404. The guide roller 404 is free to rotate and maintains a proper alignment of the belt 400. The guide roller 404 features a first alignment feature 704 and a second alignment feature 706 (collectively alignment features 704). In the depicted embodiment, the first and second alignment features 604,606 are tapered ends of the guide roller 404. The ends are tapered such that the radius at either end of the guide roller 404 is less than the radius in the middle of the guide roller 404. This configuration causes the belt 400 to remain centered on the guide roller 404 during rotation.

Returning to FIG. 5, the tensioning roller 406 is mechanically linked to the tensioner 408. The tensioner 408 acts to tighten and slacken the belt 400 by causing the tensioning roller 406 to extend into the belt 400 to tighten or to retract from the platen belt 400 to slacken. It is necessary to slacken the belt 400 when it needs to be removed and replaced. As depicted in FIGS. 4 and 5, the tensioner 408 includes a tensioning wheel 410 that is part of a rack and pinion system 530 such that rotation of the tensioning wheel 410 causes a support rack 420 of the rack and pinion system 530 to extend outwards or retract inwards. The support rack 420 is connected to a support frame 430, the support frame 430 is designed to rotatably support the tensioning roller 406. A locking nut 440 is meshed with the tensioning wheel 410 such that the locking nut 440 is loosened to allow the tensioning wheel 410 to rotate and the locking nut 440 is tightened to lock the tensioning wheel 410 in place.

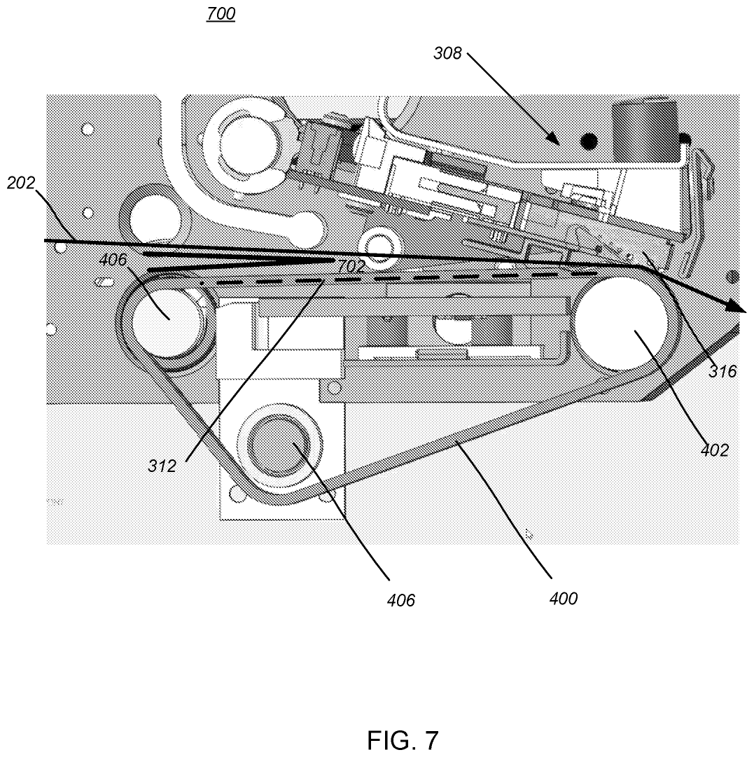

FIG. 7 depicts another embodiment of the belt 400. The embodiment depicted in FIG. 7 are for printers having a printhead mechanism 308 on a bottom side of the printer 700. The platen belt 400 can be seen at the bottom of the printer 700, where the media feed path 202 passes over the platen roller 402, between the printhead 316 and the belt 400. The belt 400 has a platen length 312 (designated with dotted line) as the belt 400 is approaching the platen roller 402.

FIG. 7 further depicts angle 702 which is representative of the angle between the feed path 202 and the platen length 312. The angle 702 allows for the feed path 202 and the belt 400 to remain separated during printing, only coming into contact proximate to the platen roller 402 and/or the print line 320. The angle 702 can be an oblique angle. In one example, the angle 702 can be between 1 degree and 90 degrees, or between 1 degree and 20 degrees, or between 30 degrees and 40 degrees. As an example, the media can contact less than twenty-five percent (25%) of the belt as it is advanced along the feed path by the belt. As another example, the media can contact less than ten percent (10%) of the belt as it is advanced along the feed path by the belt. As another example, the media can contact less than ten percent (5%) of the belt as it is advanced along the feed path by the belt.

The above description refers to diagrams of the accompanying drawings. Alternative implementations of the example represented by the diagrams include one or more additional or alternative elements, processes and/or devices. Additionally, or alternatively, one or more of the example elements of the diagram may be combined, divided, re-arranged or omitted.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

We claim:

1. A printer comprising:
a platen assembly including a belt, a platen roller, a guide roller, and a tensioning roller, wherein the belt is driven by the platen roller along a belt path;
a printer outlet positioned adjacent to the platen assembly; and
a media feed path extending from a media supply to the printer outlet, wherein the media feed path passes adjacent to the platen roller;
wherein the belt path intersects the media feed path in proximity to the platen roller at an oblique angle.

2. The printer of claim 1, wherein the platen assembly further includes a tensioner configured to adjust the tensioning roller to modify tension in the belt.

3. The printer of claim 1, wherein the media supply is linerless media.

4. The printer of claim 1, wherein the platen roller includes a plurality of pins configured to interact with the belt.

5. The printer of claim 4, wherein the belt includes a plurality of pin holes configured to receive the plurality of pins.

6. The printer of claim 1, wherein the platen roller is positioned adjacent to a printhead assembly within the printer.

7. The printer of claim 1, wherein the belt path intersects the media feed path at an angle of 30-35 degrees.

8. The printer of claim 1, wherein the belt is replaceable.

9. The printer of claim 1, wherein the guide roller includes alignment features configured to maintain alignment of the belt on the platen assembly.

10. The printer of claim 9, wherein the alignment features include tapered ends of the guide roller.

11. The printer of claim 1, wherein the belt is in contact with media over less than 10% of the belt at any time during operation.

12. A platen assembly comprising:
a belt configured to drive the media past a printhead assembly, the platen belt including a plurality of pin holes;
a platen roller configured to drive the belt around the belt assembly, the platen roller including a plurality of pins concentrically arranged around the platen roller, the plurality of pins configured to align with the plurality of pin holes;
a guide roller configured to maintain alignment of the belt as it passes around the platen assembly; and
a tensioning roller configured to control the tension on the belt.

13. The platen assembly of claim 12, further comprising a tensioner configured to adjust a position of the tensioning roller.

14. The platen assembly of claim 13, wherein the tensioner comprises a rack and pinion system and a tensioning wheel configured to drive the rack and pinion system to adjust the position of the tensioning roller.

15. The platen assembly of claim 12, wherein the tensioning roller can be adjusted for removal of the belt.

16. A printer comprising:
a printhead;
a platen assembly including a belt, a platen roller, a guide roller, and a tensioning roller, the belt is driven by the platen roller along a belt path, the printhead and the platen roller forming a nip; and
a media feed path extending from a media supply to a printer outlet, wherein the media feed path passes adjacent to the platen roller;
wherein the belt path intersects the media feed path in proximity to the platen roller at an angle of 1-20 degrees.

17. The printer of claim 16, wherein the media supply is linerless media.

18. The printer of claim 16, wherein the belt is in contact with media over less than 10% of the belt at any time during operation.
